(19) United States
(12) Patent Application Publication
(10) Pub. No.: US 2009/0100064 A1
(43) Pub. Date: Apr. 16, 2009

(54) METHODS, COMPUTER PROGRAM PRODUCTS, AND SYSTEMS FOR AUTOMATING DISTRIBUTION OF DIGITAL MEDIA

(75) Inventor: Craig Cavanaugh, Atlanta, GA (US)

Correspondence Address: AT&T Legal Department - CC;Attn: Patent Docketing, Room 2A-207, One AT&T Way, Bedminster, NJ, 07921, US

(73) Assignee: AT&T BLS INTELLECTUAL PROPERTY, INC.,, Wilmington, DE (US)

(21) Appl. No.: 11/871,293

(22) Filed: Oct. 12, 2007

(51) Int. Cl. G06F 17/30

(52) U.S. Cl. 707/10; 707/E17.001

(57) ABSTRACT

A digital media content file containing electronically captured content is received over a network. The received digital media content file is associated with at least one destination identifier specifying a destination for the electronically captured content and at least one output medium identifier specifying an output medium for the electronically captured content. An output medium is produced that includes the electronically captured content using the at least one output medium identifier. The produced output medium is sent to the destination specified by the at least one destination identifier.

### TECHNICAL FIELD

Exemplary embodiments relate generally to electronic content distribution and, more specifically, to methods, computer program products, and systems for automating distribution of digital media.

### BACKGROUND

For many users, managing digital media such as photos, video clips and sound clips may be difficult. After digital media is captured on a first device, it may be necessary to transfer the media to a second device in order to permit the media to be processed, edited and forwarded to third parties. For example, a user may capture a still video image on a camera-equipped cellular telephone, and then transfer the image to a computing device that is capable of executing image processing software. The user crops the image, males adjustments to brightness, intensity and hue, compresses the image, and send the image to a number of family members, friends and acquaintances in the form of an email attachment. Alternatively, the user may forward the captured image to email, and download a number of captured images to the website of an online photo processing service such as Ofoto™ or Flicker™. The online photo processing service prints the captured images and sends the physical prints to the user, or stores the captured images on a DVD and mails the DVD to the user, or both.

Sending electronic copies of digital media to third parties may be a laborious, time consuming process. Although it is possible to upload a group of image files to an email message in the form of one or more attachments, this may be cumbersome and inconvenient if a number of large image files are involved. Moreover, the recipient may have a limitation on the maximum amount of storage space in their email in-box. If the file attachments exceed the size of a recipient's mailbox storage, the recipient will be unable to view the attachments. Likewise, third parties may lack the necessary hardware or software for viewing digital media and, in such cases, it may be necessary to provide them with printed copies of the media.

### SUMMARY

Exemplary embodiments relate to methods, computer program products, and systems for automating distribution of digital media. The methods include receiving a digital media content file over a network, the digital media content file containing electronically captured content. The received digital media content file is associated with at least one destination identifier specifying a destination for the electronically captured content and at least one output medium identifier specifying an output medium for the electronically captured content. An output medium is produced that includes the electronically captured content using the at least one output medium identifier. The produced output medium is sent to the destination specified by the at least one destination identifier.

Another set of exemplary embodiments include computer program products for automating distribution of digital media. The computer program products include a storage medium readable by a processing circuit and storing instructions for execution by the processing circuit for facilitating a method. The method includes receiving a digital media content file over a network, the digital media content file containing electronically captured content. The received digital media content file is associated with at least one destination identifier specifying a destination for the electronically captured content and at least one output medium identifier specifying an output medium for the electronically captured content. An output medium is produced that includes the electronically captured content using the at least one output medium identifier. The produced output medium is sent to the destination specified by the at least one destination identifier.

Another set of exemplary embodiments include systems for automating distribution of digital media. An application server receives a digital media content file over a network, the digital media content file containing electronically captured content. At least one of the application server or a media capturing device associates the received digital media content file with at least one destination identifier specifying a destination for the electronically captured content and at least one output medium identifier specifying an output medium for the electronically captured content. An output mechanism produces an output medium that includes the electronically captured content using the at least one output medium identifier. The produced output medium is sent to the destination specified by the at least one destination identifier.

Other methods, computer program products, and apparatuses according to embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 is a simplified block diagram of an exemplary communication system used to automate distribution of digital media.

FIG. 2 is a flowchart of an exemplary procedure for automating distribution of digital media.

The detailed description explains the exemplary embodiments, together with advantages and features, by way of example with reference to the drawings.

### DETAILED DESCRIPTION

In the following detailed description, numerous specific details are set forth in order to provide a thorough understanding of embodiments. However it will be understood by those of ordinary skill in the art that the embodiments may be practiced without these specific details. In other instances, well-known methods, procedures, components and circuits have not been described in detail so as not to obscure the embodiments.

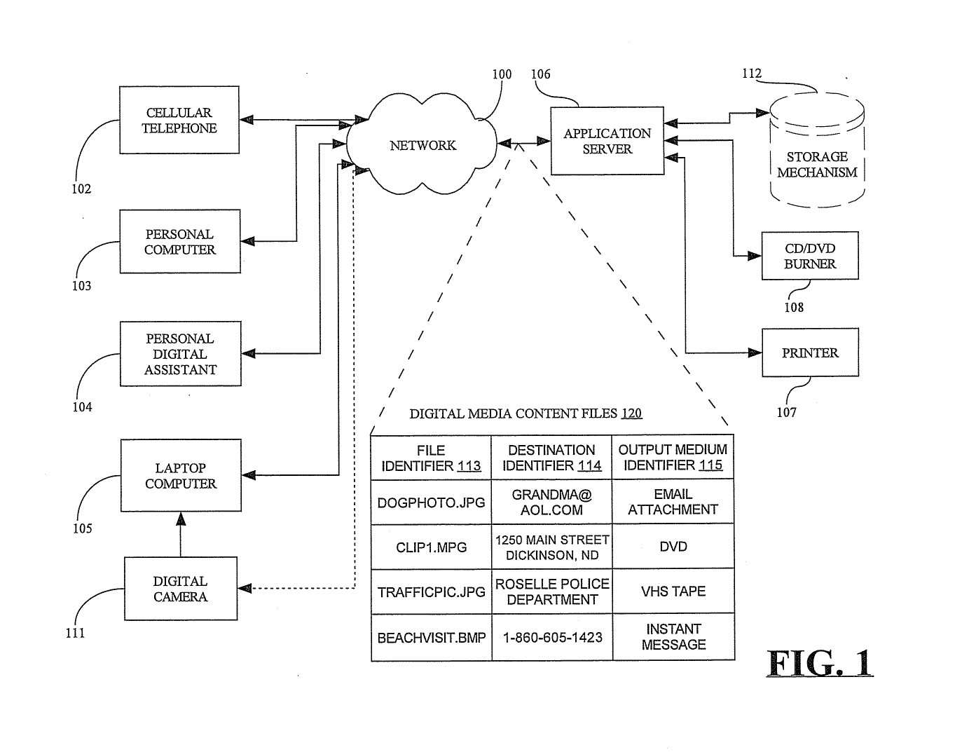

FIG. 1 is a simplified block diagram of an exemplary communication system used to automate distribution of digital media. An application server 106 receives a digital media content file over a network 100, the digital media content file containing electronically captured content. The content may be captured by a media capturing device illustratively implemented by a cellular telephone 102 equipped with a camera, a personal computer 103 equipped with a webcam, a personal digital assistant 104, a laptop computer 105, or a digital camera 111. The media capturing device is operatively coupled to the network 100.

At least one of the application server 106 or the media capturing device associates a file identifier 113 identifying the received digital media content file with at least one destination identifier 114 specifying a destination for the electronically captured content and at least one output medium identifier 115 specifying an output medium for the electronically captured content. For example, digital media content files 120 may include the file identifier 113 specifying a file named dogphoto.jpg, illustratively corresponding to a digital photograph of a dog. This .jpg file is associated with the destination identifier 114 specifying a recipient's email address in the form of grandma@aol.com, and the output medium identifier 115 specifying an email attachment. The digital media content files 120 may, but need not, be electronically stored in a storage mechanism 112 such as a computer disk drive, an optical storage medium, semiconductor memory storage, or another type of storage mechanism.

By way of example, the digital media content files 120 may include the file identifier 113 specifying a file named clip1.mpg, illustratively corresponding to a moving video clip. This .mpg file is associated with the destination identifier 114 specifying a physical address (1250 Main Street, Dickinson, N. Dak.), and the output medium identifier 115 specifying a DVD. Pursuant to a third example for the digital media content files 120, the file identifier 113 specifies trafficpic.jpg corresponds to a photograph taken by a camera that monitors traffic flow and signal light status at a busy intersection. This .jpg file is associated with the destination identifier 114 specifying a physical location or organization in the form of the Roselle Police Department, and the output medium identifier 115 specifying a VHS tape. Finally, a fourth example for the digital media content files 120 includes the file identifier 113 specifying beachvisit.bmp, corresponding to a photograph taken by a person visiting a beach. This .bmp file is associated with the destination identifier 114 specifying a telephone number and the output medium identifier 115 specifying an instant message.

An output mechanism produces an output medium that includes the electronically captured content using the at least one output medium identifier 115. For example, the output mechanism may include any of a CD/DVD burner 108, a printer 107, or the application server 106 generating an output medium in the form of an electronic file. The produced output medium is sent to the destination specified by the at least one destination identifier 115. This destination may correspond to an email in-box, a device capable of receiving an electronic file from the network 100 such as the cellular telephone 102, the personal computer 103, the personal digital assistant 104, or the laptop computer 105. Alternatively or additionally, this destination may correspond to a physical location, a physical address, or an organization to which a physical medium such as a DVD or VHS tape will be sent.

A non-exhaustive list of examples for the network 100 includes wired or optical networks such as the Internet, intranets, Ethernet networks, token rings, Universal Serial Bus (USB), wired networks according to the IEEE 1394-1995, IEEE 1394a-2000, and IEEE 1394b standards (commonly known as “FireWire”), or any combination thereof. Network 100 may include any combination of additional communication devices (not shown) such as gateways, routers, switches, and the like. Additionally or alternatively, network 100 may include wireless networks such as Direct Sequence—Code Division Multiple Access (DS-CDMA), Global System for Mobile Communications (GSM), North American Digital Cellular (NADC), Time Division Multiple Access (TDMA), Extended-TDMA (E-TDMA), W-CDMA, GPRS, GSM, Enhanced Data for GSM Evolution (EDGE), 3G and 4G communication, wireless local area networks such as 802.11, Bluetooth™, Zigbee™, ultra wideband (UWB), or various combinations thereof.

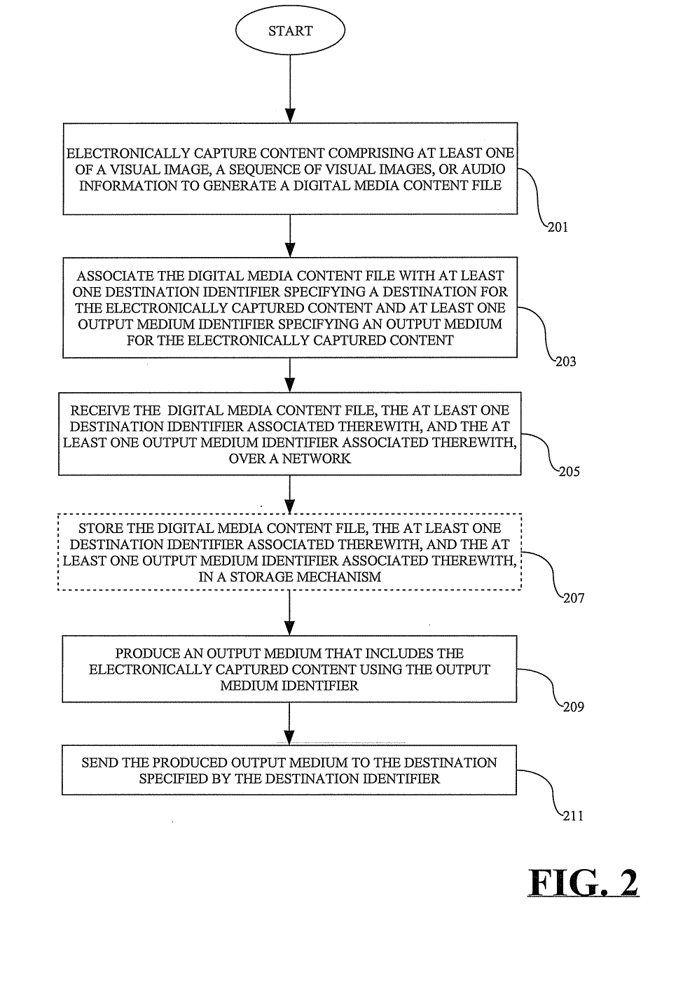

FIG. 2 is a flowchart of an exemplary procedure for automating distribution of digital media. The procedure commences at block 201 where content is electronically captured to generate a digital media content file. Illustratively, the content is captured by a media capturing device comprising any of the cellular telephone 102 (FIG. 1), the personal computer 103, the personal digital assistant 104, the laptop computer 105, or the digital camera 111. The captured content comprises at least one of a visual image, a sequence of visual images, or audio information. A sequence of visual images may represent full motion video, a video clip, an animation, or any of various combinations thereof.

Next, at block 203 (FIG. 2), the digital media content file is associated with at least one destination identifier, such as the destination identifier 114 (FIG. 1), specifying a destination for the electronically captured content and at least one output medium identifier, such as the output medium identifier 115, specifying an output medium for the electronically captured content. This step may be performed automatically by the media capturing device, or in response to user input received at the media capturing device, or automatically by the application server 106, or in response to user input received by the application server 106 over the network 100, or any of various combinations thereof. For example, the destination identifier 114 and the output medium identifier 115 are illustratively specified by input received from a user, or are generated by the media capturing device or the application server 106 in response to input received from a user. Alternatively or additionally, default values for the destination identifier 114 or the output medium identifier 115 or both may be stored in the media capturing device 114 or the application server 106. Alternatively or additionally, the output medium identifier 115 may be generated based upon a file type or file extension for the digital media content file. The media content device illustratively associates the file identifier 113 with the digital media content file contemporaneously with the media being captured. For example, a media capturing device such as a digital camera automatically generates a file identifier 113 in the form of a name, such as DSC0013.jpg, for each digital media content file captured by that device.

At block 205 (FIG. 2), the digital media content file, the at least one destination identifier 114 (FIG. 1) associated therewith, and the at least one output medium identifier 115 associated therewith, are received by the application server 106. For example, the digital media content file, the at least one destination identifier 114 (FIG. 1) associated therewith, and the at least one output medium identifier 115 associated therewith, are emailed to the application server 106. Alternatively or additionally, the digital media content file, the at least one destination identifier 114 (FIG. 1) associated therewith, and the at least one output medium identifier 115 associated therewith, are uploaded to a website associated with the application server 106. Alternatively or additionally, the digital media content file and a user identifier is received by the application server 106 whereupon the application server 106 automatically associates the digital media content file with the destination identifier 114 and the output medium identifier 115 based upon user profile information stored in the storage mechanism 112 for a user identified by the user identifier. Alternatively or additionally, the digital media content file is received by the application server 106 whereupon the application server 106 associates the digital media content file with the destination identifier 114 and the output medium identifier 115 based upon user input received over the network 100.

The procedure of FIG. 2 advances to optional block 207 where the digital media content file, the destination identifier 114 associated therewith, and the output medium identifier 115 associated therewith, are stored in the optional storage mechanism 112 (FIG. 1). As indicated above, the optional storage mechanism 112 may store an optional user profile for each of one or more users. The user profile associates a respective user identifier with at least one corresponding destination identifier, such as the destination identifier 114, or at least one corresponding output medium identifier, such as the output medium identifier 115, or both.

Program control advances to block 209 (FIG. 2) from optional block 207 or from block 205. At block 209, an output medium is produced that includes the electronically captured content using the output medium identifier 115 (FIG. 1). If the output medium identifier 115 specifies a DVD or CD, then the output medium is produced by the CD/DVD burner 108. If the output medium identifier 115 specifies a hard copy, then the output medium is produced by the printer 107 (FIG. 1). If the output medium identifier 115 specifies an electronic file attachment or an instant message, then the output medium is generated in electronic form by the application server 106.

At block 211 (FIG. 2), the produced output medium is sent to the destination specified by the destination identifier 114 (FIG. 1). In the case of an electronic file attachment or instant message, this step is performed by the application server 106 sending the file attachment or instant message to an electronic destination specified by the destination identifier 114. This electronic destination may, but need not, comprise an email address or a telephone number or both. In the case of a DVD, CD, printed hard copy or other physically tangible medium, this step is performed by forwarding the physically tangible medium to a physical location, physical address, or organization specified by the destination identifier 114.

As described above, the exemplary embodiments can be in the form of computer-implemented processes and apparatuses for practicing those processes. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for automating distribution of digital media, the method including:
receiving a digital media content file over a network, the digital media content file containing electronically captured content;
associating the received digital media content file with at least one destination identifier specifying a destination for the electronically captured content and at least one output medium identifier specifying an output medium for the electronically captured content;
producing an output medium that includes the electronically captured content using the at least one output medium identifier; and
sending the produced output medium to the destination specified by the at least one destination identifier.

2. The method of claim 1 wherein the digital media content file contains at least one of a visual image, a sequence of visual images, or audio information.

3. The method of claim 1 wherein the received digital media content file is received with the associated destination identifier and the associated output medium identifier.

4. The method of claim 1 further including receiving a user identifier associated with the digital media content file.

5. The method of claim 4 further including storing a user profile associated with the user identifier, wherein the user profile associates the user identifier with at least one corresponding destination identifier and at least one corresponding output medium identifier.

6. The method of claim 5 wherein the received digital media content file is associated with the at least one destination identifier and the at least one output medium identifier by retrieving the at least one destination identifier and the at least one output medium identifier from the user profile.

7. The method of claim 1 further including storing the digital media content file, the at least one destination identifier associated therewith, and the at least one output medium identifier associated therewith.

8. A computer program product for automating distribution of digital media, the computer program product including a storage medium readable by a processing circuit and storing instructions for execution by the processing circuit for facilitating a method comprising:
receiving a digital media content file over a network, the digital media content file containing electronically captured content;
associating the received digital media content file with at least one destination identifier specifying a destination for the electronically captured content and at least one output medium identifier specifying an output medium for the electronically captured content;
producing an output medium that includes the electronically captured content using the at least one output medium identifier; and
sending the produced output medium to the destination specified by the at least one destination identifier.

9. The computer program product of claim 8 wherein the digital media content file contains at least one of a visual image, a sequence of visual images, or audio information.

10. The computer program product of claim 8 wherein the received digital media content file is received with the associated destination identifier and the associated output medium identifier.

11. The computer program product of claim 8 further including receiving a user identifier associated with the digital media content file.

12. The computer program product of claim 11 further including storing a user profile associated with the user identifier, wherein the user profile associates the user identifier with at least one corresponding destination identifier and at least one corresponding output medium identifier.

13. The computer program product of claim 12 wherein the received digital media content file is associated with the at least one destination identifier and the at least one output medium identifier by retrieving the at least one destination identifier and the at least one output medium identifier from the user profile.

14. The computer program product of claim 8 further including storing the digital media content file, the at least one destination identifier associated therewith, and the at least one output medium identifier associated therewith.

15. A system for automating distribution of digital media, the system comprising:
an application server, operatively coupled to a network, for receiving a digital media content file over the network, the digital media content file containing electronically captured content, wherein at least one of the application server or a media capturing device associates the received digital media content file with at least one destination identifier specifying a destination for the electronically captured content and at least one output medium identifier specifying an output medium for the electronically captured content; and
an output mechanism, operatively coupled to the network, for producing an output medium that includes the electronically captured content using the at least one output medium identifier, wherein the produced output medium is capable of being sent to the destination specified by the at least one destination identifier.

16. The system of claim 15 wherein the digital media content file contains at least one of a visual image, a sequence of visual images, or audio information.

17. The system of claim 15 wherein the received digital media content file is received with the associated destination identifier and the associated output medium identifier.

18. The system of claim 15 wherein the application server receives user identifier associated with the digital media content file.

19. The system of claim 18 further including a storage mechanism operatively coupled to the application server for storing a user profile associated with the user identifier, wherein the user profile associates the user identifier with at least one corresponding destination identifier and at least one corresponding output medium identifier.

20. The system of claim 19 wherein the received digital media content file is associated with the at least one destination identifier and the at least one output medium identifier by the application server retrieving the at least one destination identifier and the at least one output medium identifier from the user profile.
